(19) United States
(12) Patent Application Publication
(10) Pub. No.: US 2026/0307482 A1
(43) Pub. Date: Oct. 8, 2026

(54) IN-VEHICLE SYSTEM, VEHICLE, AND INFORMATION PROCESSING DEVICE

(71) Applicant: TOYOTA JIDOSHA KABUSHIKI KAISHA, Toyota-shi (JP)

(72) Inventors: Junichi TODAKA, Seto-shi (JP); Akinori SHIN, Toyota-shi (JP); Sara YAMAFUJI, Miyoshi-shi (JP); Kazuyuki SHIGA, Nisshin-shi (JP); Miki TSUJINO, Ichinomiya-shi (JP); Ryota HAMABE, Nisshin-shi (JP); Seiichi TANAKA, Toyota-shi (JP); Kanako MATSUMOTO, Tokyo (JP); Hirotake SANO, Nagakute-shi (JP); Takashi OSAWA, Toyota-shi (JP); Hisashi FUJIWARA, Nisshin-shi (JP)

(73) Assignee: TOYOTA JIDOSHA KABUSHIKI KAISHA, Toyota-shi (JP)

(21) Appl. No.: 19/634,250

(22) Filed: Mar. 31, 2026

(30) Foreign Application Priority Data
Apr. 2, 2025 (JP) 2025-061160

(51) Int. Cl. B60K 35/22; B60K 35/10; B60K 35/28; B60K 35/29; B60K 35/81; G06F 3/04817

(52) U.S. Cl. CPC B60K 35/22; B60K 35/10; B60K 35/28; B60K 35/29; B60K 35/81; G06F 3/04817; B60K 2360/115; B60K 2360/1438; B60K 2360/175; B60K 2360/84

(57) ABSTRACT

An in-vehicle system includes: a display device including a first display and a second display; and one or more processors configured to control the display device, wherein the first display is configured to display interfaces relating respectively to a plurality of first functions; the second display is configured to display interfaces relating respectively to a plurality of second functions, the second functions being functions including a function of outputting proposal information; and the one or more processors are configured to output the proposal information to the first display in a case where an interface relating to the first functions that corresponds to a proposal condition being met is displayed on the first display when the proposal condition is met, the proposal condition being a condition under which information relating to the first functions is supposed to be output as the proposal information.

### CROSS-REFERENCE TO RELATED APPLICATION

This application claims priority to Japanese Patent Application No. 2025-061160 filed on Apr. 2, 2025. The disclosure of the above-identified application, including the specification, drawings, and claims, is incorporated by reference herein in its entirety.

### BACKGROUND

### 1. Technical Field

The present disclosure relates to an in-vehicle system, a vehicle, and an information processing device.

### 2. Description of Related Art

Japanese Unexamined Patent Application Publication No. 2024-76752 (JP 2024-76752 A) discloses a technology relating to a driving assistance system. In the driving assistance system disclosed in JP 2024-76752 A, at least one function among a plurality of functions belonging to an automobile is assigned to a first function that is activated by one switch operation, and at least one of the other functions is assigned to a second function that is activated by multiple switch operations. A proposal function is selected that is deemed as desired to be presented to the driver from among the functions based on at least either the driver's manipulation history or the state of the automobile. When the selected proposal function is included in first functions, a message prompting the driver to use the proposal function is output. When the selected proposal function is included in second functions, a message that prompts the driver to use the proposal function is not output.

### SUMMARY

The present disclosure provides an in-vehicle system, a vehicle, and an information processing device that improve convenience in the case where information is provided to a user (driver) by a display device having a plurality of display units.

An in-vehicle system according to a first aspect of the present disclosure includes: a display including a first display and a second display; and one or more processors configured to control the display, wherein: the first display is configured to display interfaces each including a manipulation icon that is manipulated by a driver of a vehicle, the interfaces being interfaces relating respectively to a plurality of first predetermined functions belonging to the vehicle; the second display is configured to display interfaces relating respectively to a plurality of second predetermined functions belonging to the vehicle, the second predetermined functions being functions other than the first predetermined functions and including an agent function of outputting proposal information for the driver; and the one or more processors are configured to execute outputting the proposal information to the first display in a case where an interface relating to one of the first predetermined functions that corresponds to a predetermined proposal condition being met is displayed on the first display when the predetermined proposal condition is met, the predetermined proposal condition being a condition under which information relating to one of the first predetermined functions is supposed to be output as the proposal information by the agent function.

A vehicle according to a second aspect of the present disclosure includes the in-vehicle system in the above-described aspect.

An information processing device according to a third aspect of the present disclosure includes one or more processors configured to control a display, wherein the display includes a first display and a second display; the first display is configured to display interfaces each including a manipulation icon that is manipulated by a driver of a vehicle, the interfaces being interfaces relating respectively to a plurality of first predetermined functions belonging to the vehicle; the second display is configured to display interfaces relating respectively to a plurality of second predetermined functions belonging to the vehicle, the second predetermined functions being functions other than the first predetermined functions and including an agent function of outputting proposal information for the driver; and the one or more processors are configured to execute outputting the proposal information to the first display in a case where an interface relating to one of the first predetermined functions that corresponds to a predetermined proposal condition being met is displayed on the first display when the predetermined proposal condition is met, the predetermined proposal condition being a condition under which information relating to one of the first predetermined functions is supposed to be output as the proposal information by the agent function.

The present disclosure can improve convenience in the case where information is provided to a user (driver) by a display device having a plurality of display units.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view showing a state of a front part inside a vehicle cabin of a vehicle according to an embodiment;

FIG. 2 is a view showing a schematic configuration of a display device and its surroundings;

FIG. 3 is a block diagram schematically showing one example of a hardware configuration of a system installed in the vehicle;

FIG. 4 is a block diagram schematically showing one example of a functional configuration of an ECU;

FIG. 5A is one example of a first view showing an example of a plurality of interface screens displayed on an outer display;

FIG. 5B is one example of the first view showing an example of the interface screens displayed on the outer display;

FIG. 6A is one example of a second view showing an example of the interface screens displayed on the outer display;

FIG. 6B is one example of the second view showing an example of the interface screens displayed on the outer display;

FIG. 6C is one example of the second view showing an example of the interface screens displayed on the outer display;

FIG. 6D is one example of the second view showing an example of the interface screens displayed on the outer display;

FIG. 7A is one example of a first view showing an example of a plurality of interface screens displayed on an inner display;

FIG. 7B is one example of the first view showing an example of the interface screens displayed on the inner display;

FIG. 8A is one example of a second view showing an example of the interface screens displayed on the inner display;

FIG. 8B is one example of the second view showing an example of the interface screens displayed on the inner display;

FIG. 8C is one example of the second view showing an example of the interface screens displayed on the inner display;

FIG. 8D is one example of the second view showing an example of the interface screens displayed on the inner display;

FIG. 9 is a view showing one example of a table configuration of an activation history database;

FIG. 10A is a view showing one example of a table configuration of a proposal information database;

FIG. 10B is a view showing one example of the table configuration of the proposal information database;

FIG. 11 is a flowchart showing a control flow for outputting proposal information for a first predetermined function;

FIG. 12A is one example of a first view showing an example of displayed images on the inner display and the outer display when proposal information has been output;

FIG. 12B is one example of the first view showing an example of displayed images on the inner display and the outer display when proposal information has been output;

FIG. 13A is one example of a second view showing an example of displayed images on the inner display and the outer display when proposal information has been output;

FIG. 13B is one example of the second view showing an example of displayed images on the inner display and the outer display when proposal information has been output;

FIG. 14 is a flowchart showing a control flow for outputting proposal information for a second predetermined function; and

FIG. 15 is a view showing one example of displayed images on the inner display when proposal information has been output.

### DETAILED DESCRIPTION OF EMBODIMENTS

In recent years, in-vehicle systems including an agent function have been developed. The agent function is a function of providing various information to a user inside a vehicle cabin, such as a driver. In some in-vehicle systems including such an agent function, an interface relating to the agent function is displayed on a display provided inside the vehicle cabin. In this case, a conversation (input and output of information) is performed between the user and the vehicle through the interface relating to the agent function. That is, through the interface displayed on the display, information relating to a proposal for the user (proposal information) is output or information indicating a request from the user is input.

Meanwhile, vehicles provided with a plurality of displays inside the vehicle cabin have also been developed. In such a vehicle, interfaces relating to various functions are displayed on each of the displays. For example, an interface relating to the agent function as described above is also assigned to and displayed on one of the displays. The agent function outputs proposal information relating to various other functions. In this case, it is conceivable to always set the destination of the output of the proposal information by the agent function to a display on which the interface relating to the agent function is displayed. However, there is room for improvement about the output destination of proposal information in order to improve the user's convenience in the case where information is provided to the user in a vehicle provided with a plurality of displays inside the vehicle cabin.

In view of this, an in-vehicle system that is one aspect of the present disclosure includes: a display device including a first display unit and a second display unit; and an information processing device that controls the display device. In the display device, the first display unit displays interfaces that are interfaces relating respectively to a plurality of first predetermined functions belonging to a vehicle and that each include a manipulation icon that is manipulated by a driver of the vehicle; the second display unit displays interfaces relating respectively to a plurality of second predetermined functions belonging to the vehicle that are functions other than the first predetermined functions and include an agent function of outputting proposal information for the driver. The information processing device includes a control unit configured to execute outputting the proposal information to the first display unit when a predetermined proposal condition is met and at that time an interface relating to one of the first predetermined functions that corresponds to the predetermined proposal condition being met is displayed on the first display unit, the predetermined condition being a condition under which information relating to one of the first predetermined functions is supposed to be output as the proposal information by the agent function.

The in-vehicle system includes the display device. The display device has the first display unit and the second display unit. The first display unit displays the interfaces relating respectively to the first predetermined functions (hereinafter may also be referred to as “first interfaces”). Here, the first predetermined functions are one type of various functions belonging to the vehicle. For example, the first predetermined functions may be functions relating to control of the vehicle. Each first interface displayed on the first display unit includes a manipulation icon that is manipulated by the driver of the vehicle. That is, the first interface is configured such that not only is information displayed thereon but also the driver can manipulate the manipulation icon.

The second display unit displays the interfaces relating respectively to the second predetermined functions (hereinafter may also be referred to as “second interfaces”). Here, the second predetermined functions are one type of various functions belonging to the vehicle and are functions different from the first predetermined functions. The second predetermined functions include the agent function of outputting proposal information for the driver. That is, the second display unit is configured to display the second interface relating to the agent function.

The in-vehicle system further includes the information processing device. The information processing device includes the control unit that controls the display device. When outputting proposal information by the agent function, the control unit determines to which of the first display unit and the second display unit of the display device the proposal information should be output. Here, a condition under which information relating to a first predetermined function is supposed to be output as proposal information by the agent function is referred to a predetermined proposal condition. A proposal condition for each of the first predetermined functions is specified beforehand. Therefore, when the predetermined proposal condition for a specific first predetermined function is met, the control unit outputs the proposal information relating to that specific first predetermined function by the agent function. When the predetermined proposal condition is met and at that time the first interface relating to the first predetermined function corresponding to the predetermined proposal condition being met is displayed on the first display unit, the control unit outputs the proposal information to the first display unit.

When the first interface relating to the specific first predetermined function is displayed on the first display unit, it is highly probable that the driver is intended to manipulate a manipulation icon included in the first interface displayed. Accordingly, the driver is more likely to view the first display unit than the second display unit. In such a case, therefore, the control unit outputs the proposal information relating to the specific first predetermined function to the first display unit to help the driver grasp the proposal information. This can improve the user's (driver's) convenience in the case where information is provided to the user by a display device having a plurality of display units.

In the following, specific embodiments of the present disclosure will be described based on the drawings. Unless otherwise noted, the dimensions, materials, shapes, relative arrangement, etc., of components described in the embodiments are not intended to restrict the technical scope of the present disclosure thereto.

### First Embodiment

### Schematic Configuration of System

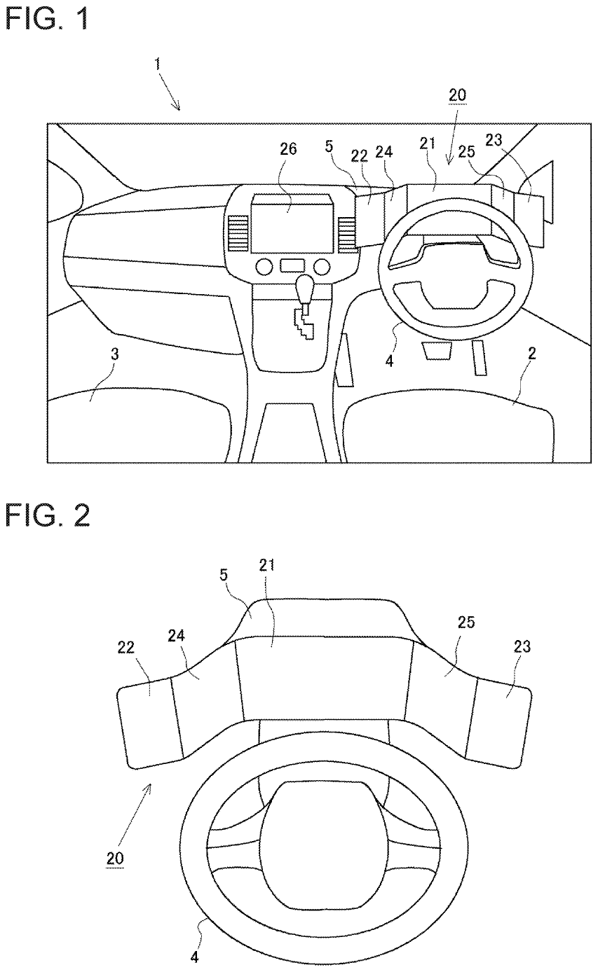

FIG. 1 is a view showing a state of a front part inside a vehicle cabin of a vehicle according to this embodiment. Inside the vehicle cabin of a vehicle 1, a driver seat 2 and a front passenger seat 3 are provided. The vehicle 1 of this embodiment is a right-hand-drive vehicle, and the driver seat 2 is provided on a right side in a forward direction of the vehicle 1. On a front side of the driver seat 2, a steering wheel 4 is provided. The steering wheel 4 may be a circular one or may be a U-shaped one (a so-called irregular-shaped steering wheel). The steering wheel 4 is connected to a steering device belonging to the vehicle 1 through a steering column. The steering column is covered by a column cover. Inside the vehicle cabin of the vehicle 1, the front passenger seat 3 is provided on the left side of the driver seat 2 (the left side in the forward direction of the vehicle 1).

On a front side inside the vehicle cabin of the vehicle 1, a display device 20 is provided. The display device 20 has a plurality of displays 21, 22, 23, 26. Specifically, the display device 20 has a meter display 21, an inner display 22, an outer display 23, and a center display 26. The meter display 21 is located on a front side of the driver seat 2, in front of the steering wheel 4 (at a substantially central part in a front-side part of the driver seat 2). The inner display 22 is located rearward and inward of the meter display 21 in the vehicle 1. The outer display 23 is located rearward and outward of the meter display 21 in the vehicle 1. The inner display 22 is connected to the meter display 21 through a connection part 24. The outer display 23 is connected to the meter display 21 through a connection part 25.

The center display 26 is located on the front side inside the vehicle cabin, at a position midway between the driver seat 2 and the front passenger seat 3 (at a substantially central part in a front-side part inside the vehicle cabin). That is, the center display 26 is provided on the front side inside the vehicle cabin, on the side of the front passenger seat 3 with respect to the meter display 21, the inner display 22, and the outer display 23.

Here, the outer side of the vehicle 1 means a side closer to an outside of the vehicle 1 as seen from the driver seat 2, and means the side of a door of the driver seat 2. The inner side of the vehicle 1 means the side of the front passenger seat 3 as seen from the driver seat 2, and means the side of a door of the front passenger seat 3. For example, in the vehicle 1 in which the steering wheel is provided on the right side of the vehicle 1, the outer side of the vehicle 1 refers to the right side of the vehicle 1 and the inner side of the vehicle 1 refers to the left side of the vehicle 1. For example, in the vehicle 1 in which the steering wheel 4 is provided on the left side of the vehicle 1, the outer side of the vehicle 1 refers to the left side of the vehicle 1 and the inner side of the vehicle 1 refers to the right side of the vehicle 1.

The meter display 21, the inner display 22, the outer display 23, and the center display 26 are all displays having a touch panel. At least the inner display 22 and the outer display 23 should have a touch panel. The meter display 21, the inner display 22, and the outer display 23 may be formed by deforming one touch screen, or may be formed by combining separate touch screens.

As the touch panel of each display of the display device 20, for example, a pressure-sensitive touch panel that detects a pressure with which a user presses the panel, or a capacitive touch panel that detects a change in capacitance when a user presses the panel can be adopted. The display is, for example, a liquid crystal display (LCD) or an electroluminescence (EL) panel. Hereinafter, that the user touches means that the user touches a touch panel.

The center display 26 may display supplementary information relating to driving (e.g., car navigation information) that is provided to the driver of the vehicle 1. The center display 26 may display information relating to entertainment, such as audio or television.

Here, a more detailed configuration of the meter display 21, the inner display 22, and the outer display 23 in the display device 20 will be described based on FIG. 2. FIG. 2 is a view showing a schematic configuration of the display device 20 and its surroundings. The meter display 21 of the display device 20 is fixed on an instrument panel 5. The meter display 21 is a horizontally long display, and the inner display 22 and the outer display 23 are vertically long displays. The meter display 21 is disposed such that the screen thereof faces a vehicle rear side, and is disposed parallel to a right-left direction of the vehicle 1 (vehicle width direction). The meter display 21 may be disposed at an angle so as to slightly face upward.

At an end portion of the meter display 21 on the vehicle inner side, a first end of the connection part 24 is connected, and the inner display 22 is connected to a second end of the connection part 24. The inner display 22 is a display that extends from an end portion of the connection part 24 on the vehicle inner side toward the rear side of the vehicle 1 as well as the inner side of the vehicle 1. The angle of the inner display 22 relative to the meter display 21 is smaller than the angle of the connection part 24 relative to the meter display 21. The connection part 24 is connected to the meter display 21 and the inner display 22 while curving. The connection part 24 has a curved surface that is recessed toward the vehicle front side at a junction with the meter display 21, and has a curved surface that protrudes toward the vehicle rear side at a junction with the inner display 22. The meter display 21 and the inner display 22 may have a curved surface.

At an end portion of the meter display 21 on the vehicle outer side, a first end of the connection part 25 is connected, and the outer display 23 is connected to a second end of the connection part 25. The outer display 23 is a display that extends from an end portion of the connection part 25 on the vehicle outer side toward the rear side of the vehicle 1 as well as the outer side of the vehicle 1. The angle of the outer display 23 relative to the meter display 21 is smaller than the angle of the connection part 25 relative to the meter display 21. The connection part 25 is connected to the meter display 21 and the outer display 23 while curving. The connection part 25 has a curved surface that is recessed toward the vehicle front side at a junction with the meter display 21, and has a curved surface that protrudes toward the vehicle rear side at a junction with the outer display 23. The outer display 23 may have a curved surface.

The steering wheel 4 includes gripped portions that are portions gripped by the driver. Since the meter display 21, the inner display 22, the outer display 23, and the connection parts 24, 25 in the display device 20 have the shapes as described above, the inner display 22 and the outer display 23 are disposed near the gripped portions of the steering wheel 4.

The inner display 22 and the outer display 23 have an angle relative to a right-left direction of the steering wheel 4, and are each disposed so as to tilt toward the steering wheel 4. That is, the inner display 22 is disposed so as to, on the inner side of the vehicle 1, protrude farther toward the rear side of the vehicle 1, and the outer display 23 is disposed so as to, on the outer side of the vehicle 1, protrude farther toward the rear side of the vehicle 1. Thus, the inner display 22 and the outer display 23 are disposed so as to each face the driver.

The meter display 21 displays interfaces showing information needed for the vehicle 1 to travel, for example, a speed of the vehicle 1, an engine rotation speed (when the vehicle 1 has an engine), a charge-discharge status (when the vehicle 1 has a drive battery), a distance traveled, and a state of an advanced driver-assistance systems (ADAS).

The outer display 23 displays interfaces relating respectively to a plurality of first predetermined functions among functions belonging to the vehicle 1 (hereinafter may also be referred to as “first interfaces”). Here, the first predetermined functions include a function relating to control of the vehicle 1. The inner display 22 displays interfaces relating respectively to a plurality of second predetermined functions different from the first predetermined functions among the functions belonging to the vehicle 1 (hereinafter may also be referred to as “second interfaces”). Here, the second predetermined functions include a function relating to convenience for an occupant of the vehicle 1. Each first interface displayed on the outer display 23 and each second interface displayed on the inner display 22 include manipulation icons (e.g., switch icons or button icons) that are manipulated by the driver of the vehicle 1. The first predetermined functions, the second predetermined functions, the first interface, and the second interface will be described in detail later.

In this embodiment, the outer display 23 corresponds to a “first display unit” according to the present disclosure, and the inner display 22 corresponds to a “second display unit” according to the present disclosure. However, the interfaces displayed on the outer display 23 and the inner display 22 are not limited to being as described above. For example, the outer display 23 may display the second interfaces and the inner display 22 may display the first interfaces. In this case, the outer display 23 corresponds to the “second display unit” according to the present disclosure, and the inner display 22 corresponds to the “first display unit” according to the present disclosure. The configurations of the “first display unit” and the “second display unit” according to the present disclosure are not limited to the configurations of the outer display 23 and the inner display 22 as described above.

### Hardware Configuration

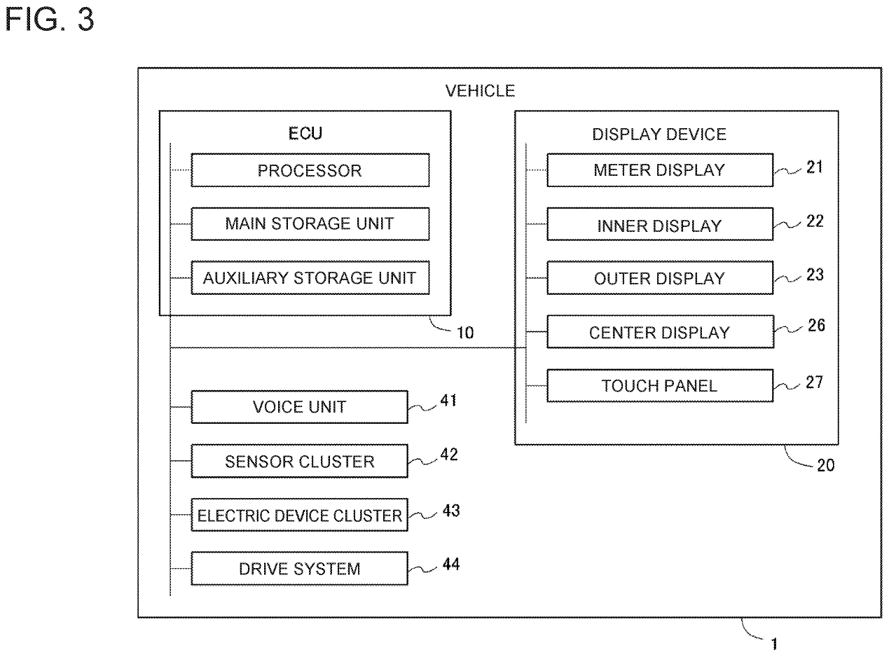

FIG. 3 is a block diagram schematically showing one example of a hardware configuration of a system installed in the vehicle 1. The system installed in the vehicle 1 includes an ECU 10, the display device 20, a voice unit 41, a sensor cluster 42, an electric device cluster 43, and a drive system 44.

The ECU 10 can be configured as a computer having a processor (a CPU, a GPU, etc.), a main storage device (an RAM, an ROM, etc.), and an auxiliary storage device (an EPROM, a hard disc drive, a removable medium, etc.). The auxiliary storage device stores an operating system (OS), various programs, various tables, etc. By executing a program stored therein, it is possible to realize a function (software module) matching a predetermined purpose as will be described later. Alternatively, some or all of the functions may be realized as a hardware module by a hardware circuit, such as an ASIC or an FPGA. The display device 20, the voice unit 41, the sensor cluster 42, the electric device cluster 43, and the drive system 44 are connected to the ECU 10. In this embodiment, the ECU 10 corresponds to an “information processing device” according to the present disclosure.

The display device 20 has the meter display 21, the inner display 22, the outer display 23, the center display 26, and the touch panel 27. The touch panel 27 is a unit for detecting touch manipulation performed on the meter display 21, the inner display 22, the outer display 23, and the center display 26. The touch panel 27 is disposed on each of the meter display 21, the inner display 22, the outer display 23, and the center display 26. Thus, each display is configured to allow manipulation by touch. The meter display 21, the inner display 22, the outer display 23, the connection parts 24, 25, and the touch panel 27 may be formed by deforming the shape of one touch screen.

The voice unit 41 is a unit that performs input and output of information by voice. The voice unit 41 may include, for example, a speaker and a microphone. The voice unit 41 can acquire a voice emitted by an occupant of the vehicle 1. The voice unit 41 can emit a voice to an occupant of the vehicle 1.

The sensor cluster 42 is an aggregate of a plurality of sensors for acquiring sensor data that is used in travel of the vehicle 1. The sensors may acquire physical amounts or may acquire image data etc. The sensor cluster 42 includes, for example, sensors that detect states of the vehicle 1 and sensors that detect actions of the driver. Specifically, the sensor cluster 42 may include a speed sensor, an acceleration sensor, an accelerator operation amount sensor, a brake sensor, a steering angle sensor, an engine rotation speed sensor, a yaw rate sensor, a winker switch sensor, a shift position sensor, a GPS sensor, a vehicle interior temperature sensor, a vehicle exterior temperature sensor, a ranging radar, and an illuminance sensor.

The speed sensor detects a speed of the vehicle 1. The acceleration sensor detects an acceleration rate of the vehicle 1. The accelerator operation amount sensor detects a position of an accelerator pedal. The brake sensor detects a position of a brake pedal. The steering angle sensor detects a steering angle of the steering wheel 4. The engine rotation speed sensor detects a rotation speed of the engine. The yaw rate sensor detects a yaw rate of the vehicle 1. The winker switch sensor detects a state of a switch of a direction indicator. The shift position sensor detects a shift position. The GPS sensor acquires position information on the vehicle 1. The vehicle interior temperature sensor detects a vehicle interior temperature. The vehicle exterior temperature sensor detects a vehicle exterior temperature. The ranging radar measures a distance to an object. The illuminance sensor detects brightness of an environment outside the vehicle 1.

The electric device cluster 43 is an aggregate of electric devices provided in the vehicle 1. The electric device cluster 43 includes vehicle control devices such as a headlight unit, a wiper actuator, a mirror actuator, and a seat actuator. The electric device cluster 43 further includes in-vehicle devices having functions other than vehicle control, such as a navigation device, a multimedia device, and an air conditioner.

The drive system 44 is a system composed of drive devices of the vehicle 1. The drive devices include, for example, an engine and/or a motor as a motive power source, a battery, and a transmission.

### Functional Configuration of ECU

Here, the functional configuration of the ECU 10 will be described based on

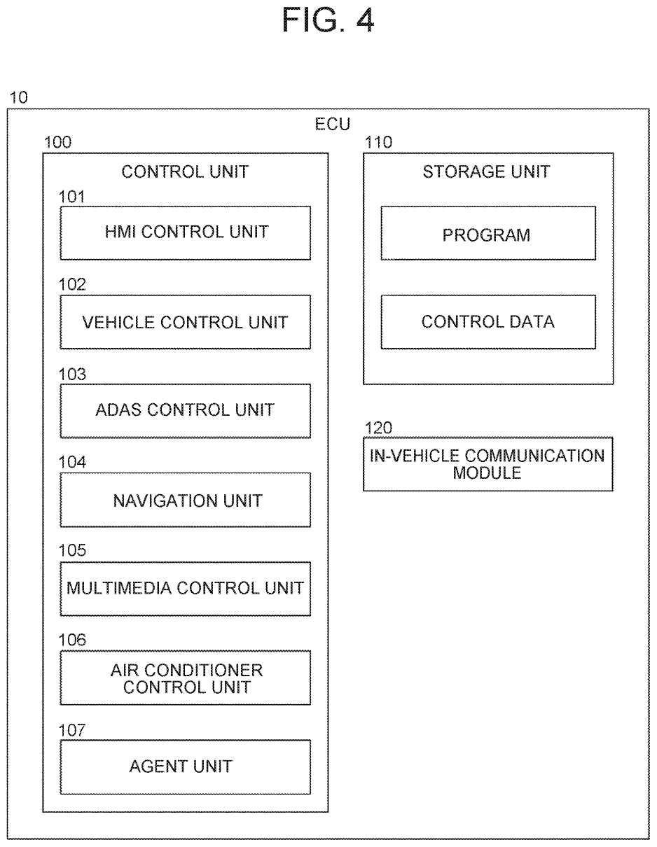

FIG. 4. FIG. 4 is a block diagram schematically showing one example of the functional configuration of the ECU. The ECU 10 includes, as functional constituent elements, a control unit 100, a storage unit 110, and an in-vehicle communication module 120. The control unit 100 is a functional constituent element that is provided, for example, as a processor executes various programs stored in the auxiliary storage unit. The control unit 100 includes, as software modules, a human-machine interface (HMI) control unit 101, a vehicle control unit 102, an ADAS control unit 103, a navigation unit 104, a multimedia control unit 105, an air conditioner control unit 106, and an agent unit 107.

The HMI control unit 101 generates interfaces relating to various functions belonging to the vehicle 1. Further, the HMI control unit 101 displays the generated interfaces on the displays belonging to the display device 20. The interfaces that are generated and displayed on the displays by the HMI control unit 101 each include manipulation icons that the driver of the vehicle 1 can manipulate. The manipulation icons are icons for the driver to control various functions belonging to the vehicle 1. The HMI control unit 101 forwards a control command that the driver has input by manipulating a manipulation icon to another software module having a function of controlling the control target device. Then, that other software module controls the control target device based on the control command received from the HMI control unit 101. Thus, the driver can control various functions through the interfaces displayed on the displays belonging to the display device 20.

The vehicle control unit 102 has a function of controlling vehicle control devices included in the electric device cluster 43. For example, the vehicle control unit 102 performs switching between on and off of headlights and switching of an irradiation mode (a high beam, a low beam, etc.) by controlling the headlight unit. The vehicle control unit 102 activates or stops a front wiper and a rear wiper by controlling the wiper actuator. The vehicle control unit 102 adjusts the angles of side-view mirrors provided one on each side of the vehicle 1 by controlling the mirror actuator. The vehicle control unit 102 adjusts the position and the angle of a seat provided in the vehicle 1 by controlling the seat actuator. The vehicle control unit 102 also has a function of controlling the drive system of the vehicle 1. For example, the vehicle control unit 102 controls a drive mode of the vehicle 1. Specifically, the drive mode of the vehicle 1 is set to a mode that the driver has selected from among a plurality of modes including a normal mode, a sport mode, an eco-mode, and a snow mode. The vehicle control unit 102 controls the drive system of the vehicle 1 based on a control command received from the ADAS control unit 103 to be described later.

The ADAS control unit 103 has a function of controlling the ADAS belonging to the vehicle 1. The ADAS control unit 103 generates a control command based on sensor information acquired from various sensors included in the sensor cluster 42. Further, the ADAS control unit 103 transmits the generated control command to the vehicle control unit 102. Thus, driving assistance such as cruise control, precrash safety, and lane keep assist are realized.

The navigation unit 104 has a navigation function. The navigation unit 104 generates a route guidance of the vehicle 1 and provides it to the driver by controlling a navigation device included in the electric device cluster 43. The navigation unit 104 outputs information relating to the generated route through the HMI control unit 101 by displaying it on a display included in the display device 20 or by a voice from the voice unit 41.

The multimedia control unit 105 has a function of controlling the multimedia device included in the electric device cluster 43. The multimedia control unit 105 controls an audio function, a television function, a radio function, a wireless communication function, etc., belonging to the multimedia device. The air conditioner control unit 106 has a function of controlling the air conditioner included in the electric device cluster 43 (air conditioner control function).

The agent unit 107 is a software module that realizes an agent function. The agent function is a function of providing various information to the user who is an occupant of the vehicle 1 by executing a language model capable of conversing by a natural language. The language model may be, for example, a large language model (LLM). The agent unit 107 outputs proposal information for the user by displaying it on a display included in the display device 20 through the HMI control unit 101. How the agent unit 107 displays proposal information on a display included in the display device 20 will be described later.

The storage unit 110 is a functional constituent element that stores information. The storage unit 110 is configured to include a main storage unit and an auxiliary storage unit. The storage unit 110 stores various programs that are executed by the control unit 100 and control data that is used to execute the various programs.

The in-vehicle communication module 120 is a functional constituent element for connecting the ECU 10 to a vehicle network using a predetermined in-vehicle communication standard. The predetermined in-vehicle communication standard can be, for example, a controller area network (CAN) or a local interconnect network (LIN). The ECU 10 communicates with various devices provided in the vehicle 1 through the in-vehicle communication module 120.

### Interface

Next, the interfaces displayed on the inner display 22 and the outer display 23 of the display device 20 will be described. As described above, the HMI control unit 101 displays a plurality of interfaces relating to the various functions belonging to the vehicle 1 on the displays belonging to the display device 20. In this case, the HMI control unit 101 displays the first interfaces relating to the first predetermined functions (functions relating to control of the vehicle 1) on the outer display 23. The HMI control unit 101 displays the second interfaces relating to the second predetermined functions (functions relating to convenience for an occupant of the vehicle 1) on the inner display 22.

In the display device 20, the output destinations of the interfaces relating to the various functions belonging to the vehicle 1 are each allocated according to the type of the corresponding function as described above. This helps the driver intuitively recognize to which of the inner display 22 and the outer display 23 the interface display contents of which the driver desires to check or manipulate will be output. Manipulation surfaces of the touch panels 27 belonging to the inner display 22 and the outer display 23 are disposed near the steering wheel 4. This can minimize the amount of movement of the line of sight and the hand of the driver when the driver tries to execute various modes of control by touch manipulation on the display.

The outer display 23 displays one of the first interfaces. The inner display 22 displays one of the second interfaces. The first interface displayed on the outer display 23 and the second interface displayed on the inner display 22 are switched by the HMI control unit 101. The driver of the vehicle 1 can switch the displayed image on each display by performing predetermined manipulation, such as a right or left swipe, on the touch panel 27 belonging to the inner display 22 or the outer display 23.

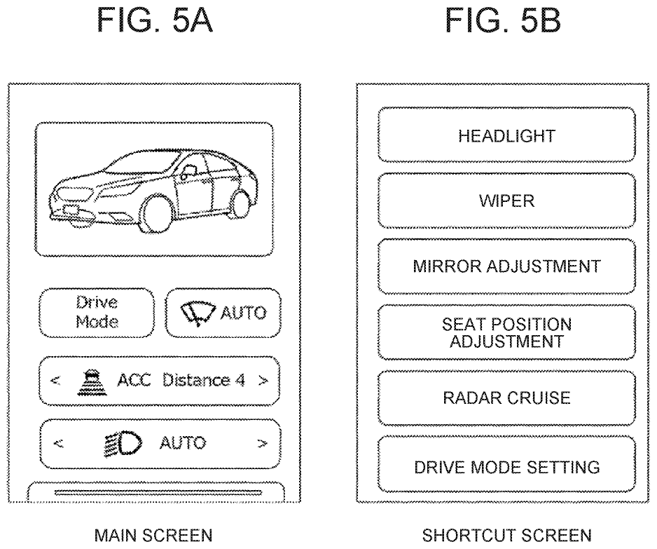

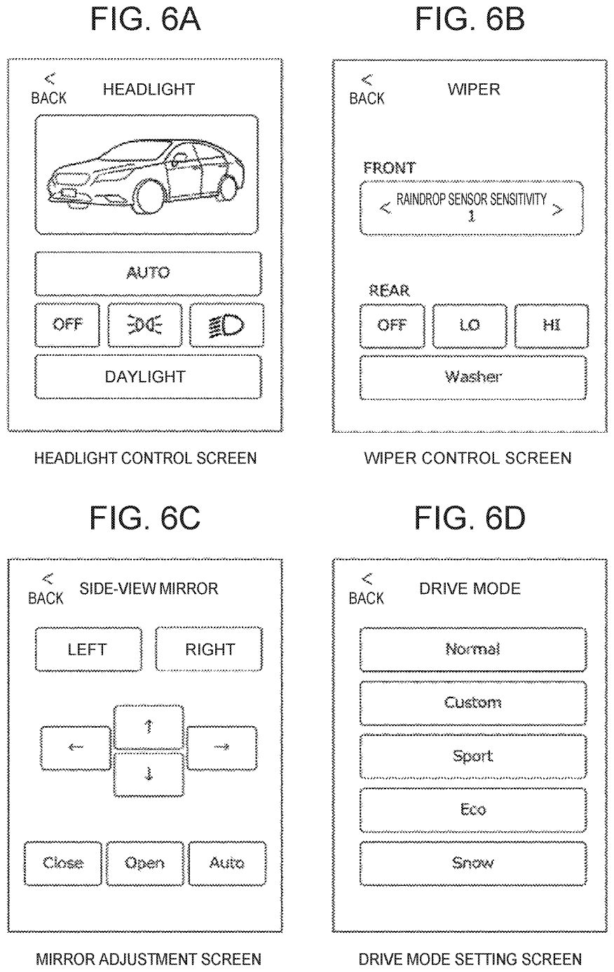

Here, the interfaces displayed on the outer display 23 will be described based on FIG. 5A, FIG. 5B, FIG. 6A, FIG. 6B, FIG. 6C, and FIG. 6D. FIG. 5A, FIG. 5B, FIG. 6A, FIG. 6B, FIG. 6C, and FIG. 6D are views showing examples of a plurality of interface screens that is displayed as the first interfaces on the outer display 23 by the HMI control unit 101. As shown in FIG. 5A and FIG. 5B, the outer display 23 displays a main screen and a shortcut screen.

### Main Screen

The main screen is an interface screen that is normally displayed on the outer display 23 while the vehicle 1 is traveling. The main screen displays manipulation icons relating to functions that are frequently used. The contents displayed on the main screen can be customized by the user.

### Shortcut Screen

The shortcut screen is an interface screen for jumping to each interface screen as will be described later that is displayed on the outer display 23 as a first interface. The shortcut screen includes manipulation icons for jumping to the respective interface screens that can be displayed on the outer display 23. As the driver selects and manipulates one of the manipulation icons included in the shortcut screen, the displayed image on the outer display 23 transitions to the interface screen relating to the function corresponding to the selected manipulation icon.

As shown in FIG. 6A, FIG. 6B, FIG. 6C, and FIG. 6D, the outer display 23 displays a headlight control screen, a wiper control screen, a mirror adjustment screen, and a drive mode setting screen as the first interfaces.

### Headlight Control Screen

The headlight control screen is an interface screen relating to the headlight control function. The headlight control screen includes manipulation icons for setting a lighting state (automatic, light on, light off, small light, daylight, etc.) of the headlights belonging to the vehicle 1. Based on manipulation that the driver has performed on the headlight control screen, the vehicle control unit 102 controls the headlight unit included in the electric device cluster 43. The headlight control screen displays the current lighting state of the headlights.

### Wiper Control Screen

The wiper control screen is an interface screen relating to the wiper control function. The wiper control screen includes manipulation icons for setting operation states (stop, automatic operation, intermittent operation, continuous operation, etc.) of the wipers (the front wiper and the rear wiper) belonging to the vehicle 1. Based on manipulation that the driver has performed on the wiper control screen, the vehicle control unit 102 controls the wiper actuator included in the electric device cluster 43. The wiper control screen displays the current operation states of the front wiper and the rear wiper.

### Mirror Adjustment Screen

The mirror adjustment screen is an interface screen relating to the mirror adjustment function. The mirror adjustment screen includes manipulation icons for adjusting a state (a retracted/deployed state, and an angle) of the side-view mirrors belonging to the vehicle 1. Based on manipulation that the driver has performed on the mirror adjustment screen, the vehicle control unit 102 controls the mirror actuator included in the electric device cluster 43. The mirror adjustment screen displays the current state of the side-view mirrors.

### Drive Mode Setting Screen

The drive mode setting screen is an interface screen relating to the drive mode setting function. The drive mode setting screen includes manipulation icons for setting the drive mode of the vehicle 1. Based on manipulation that the driver has performed on the drive mode setting screen, the vehicle control unit 102 sets the drive mode.

The above-described headlight control function, wiper control function, mirror adjustment function, and drive mode setting function are all one type of the first predetermined functions. However, the first predetermined functions are not limited to these functions. For example, the seat position adjustment function and the ADAS setting function are also one type of the first predetermined functions. The seat position adjustment function is a function of adjusting the position and the angle of a seat provided in the vehicle 1 by controlling the seat actuator by the vehicle control unit 102. The ADAS setting function is a function of controlling the ADAS belonging to the vehicle 1 by the ADAS control unit 103. The outer display 23 may display the seat position adjustment screen and the ADAS setting screen as the first interfaces. The seat position adjustment screen is an interface screen relating to the seat position adjustment function. The ADAS setting screen is an interface screen relating to the ADAS setting function.

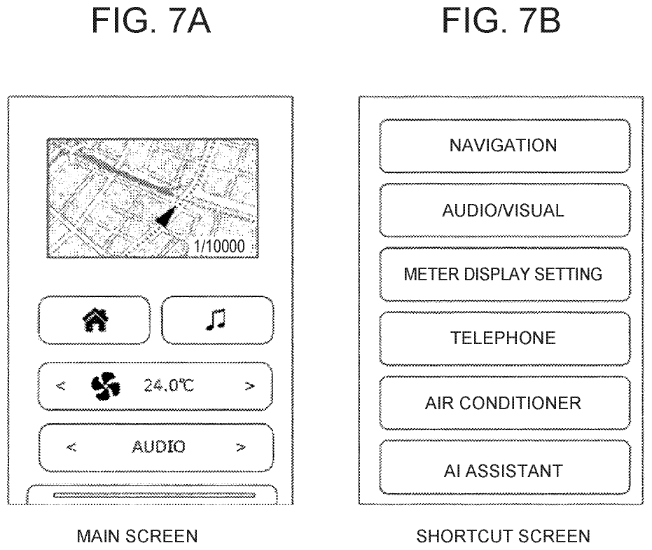

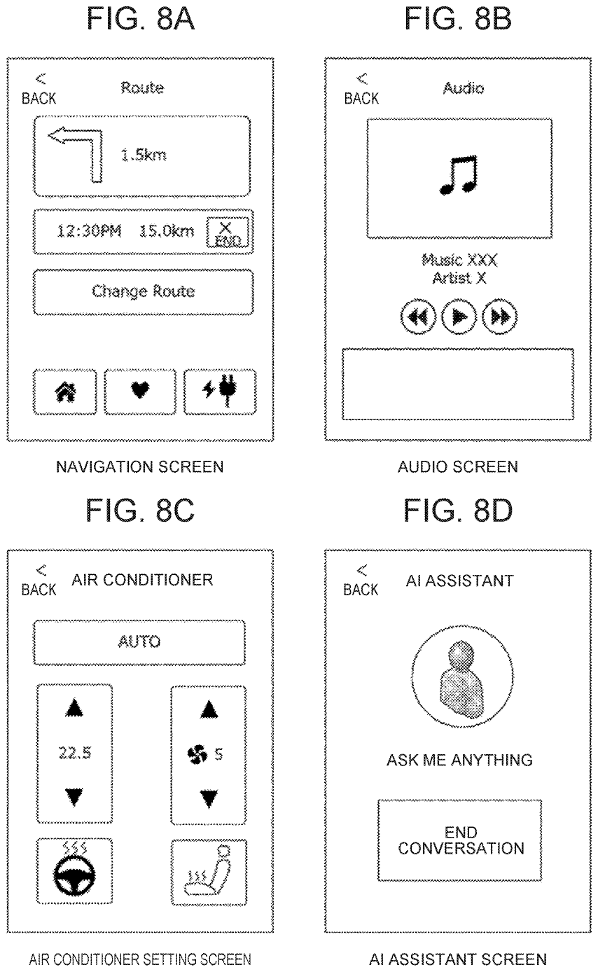

Next, the interfaces displayed on the inner display 22 will be described based on FIG. 7A, FIG. 7B, FIG. 8A, FIG. 8B, FIG. 8C, and FIG. 8D. FIG. 7A, FIG. 7B, FIG. 8A, FIG. 8B, FIG. 8C, and FIG. 8D are views showing examples of a plurality of interface screens that is displayed as the second interfaces on the inner display 22 by the HMI control unit 101. As shown in FIG. 7A and FIG. 7B, the inner display 22 displays a main screen and a shortcut screen.

### Main Screen

The main screen is an interface screen that is normally displayed on the inner display 22 while the vehicle 1 is traveling. The main screen displays manipulation icons relating to functions that are frequently used. The contents displayed on the main screen can be customized by the user.

### Shortcut Screen

The shortcut screen is an interface screen for jumping to each interface screen as will be described later that is displayed on the inner display 22 as a second interface. The shortcut screen includes manipulation icons for jumping to the respective interface screens that can be displayed on the inner display 22. As the driver selects and manipulates one of the manipulation icons included in the shortcut screen, the displayed image on the inner display 22 transitions to the interface screen relating to the function corresponding to the selected manipulation icon.

As shown in FIG. 8A, FIG. 8B, FIG. 8C, and FIG. 8D, the inner display 22 displays a navigation screen, an audio screen, an air conditioner setting screen, and an AI assistant screen as second interfaces.

### Navigation Screen

The navigation screen is an interface screen relating to the navigation function. The navigation screen displays information relating to navigation generated by the navigation unit 104. The navigation screen includes manipulation icons for destination setting, spot registration, etc.

### Audio Screen

The audio screen is an interface screen relating to the audio function belonging to the multimedia device. The audio screen includes manipulation icons for controlling the audio function (playing a music, etc.) of the multimedia device. Based on manipulation that the driver has performed on the audio screen, the multimedia control unit 105 controls the multimedia device included in the electric device cluster 43. The audio screen displays information relating to a music being played.

### Air Conditioner Setting Screen

The air conditioner setting screen is an interface screen relating to the air conditioner control function. The air conditioner setting screen includes manipulation icons for setting an operation state (a temperature, a wind volume, an air conditioning function, etc.) of the air conditioner. Based on manipulation that the driver has performed on the air conditioner setting screen, the air conditioner control unit 106 controls the air conditioner included in the electric device cluster 43. The air conditioner setting screen displays the current operation state of the air conditioner.

### AI Assistant Screen

The AI assistant screen is an interface screen relating to the agent function. The AI assistant screen is a screen for conversing with a virtual agent (AI assistant) capable of conversing by a natural language. The AI assistant screen includes a character of a virtual agent. The user can obtain information by conversing with the character on the AI assistant screen. The service of conversing by a natural language is provided by the agent unit 107. The AI assistant screen includes manipulation icons for conversing with the AI assistant.

The above-described navigation function, audio function, air conditioner control function, and agent function are all one type of the second predetermined functions. However, the second predetermined functions are not limited to these functions. For example, a telephone function is also one type of the second predetermined functions. The telephone function is a function of realizing a hands-free call by controlling a wireless communication function of the multimedia device by the multimedia control unit 105 so as to wirelessly connect to a user terminal present inside the vehicle 1. The inner display 22 may display a telephone screen as a second interface. The telephone screen is an interface screen relating to a call function.

### Agent Function

Next, the agent function realized by the agent unit 107 of the ECU 10 will be described in detail. As described above, a control command is input by the driver through each interface screen to the inner display 22 or the outer display 23 of the display device 20. The control command is a command for activating the various functions belonging to the vehicle 1. The ECU 10 accepts the control command input into the inner display 22 or the outer display 23. When the ECU 10 accepts the control command, the agent unit 107 stores, in the storage unit 110, the function that is to be activated and the contents of control in the control command in association with each other. In this case, information about the date and time when the control command has been input into the inner display 22 or the outer display 23 is also stored in the storage unit 110 as information indicating the date and time when the function to be activated has been activated (activation date and time). Further, the position of the vehicle 1 where the control command has been input into the inner display 22 or the outer display 23 is also stored in the storage unit 110 as information indicating the position where the function to be activated has been activated (activation position). Further, data detected by various sensors included in the sensor cluster 42 at the time when the control command has been input is also stored in the storage unit 110 as relevant information. The relevant information is, for example, the speed and the acceleration rate of the vehicle 1, the vehicle interior temperature, the vehicle exterior temperature, and the brightness of the environment outside the vehicle.

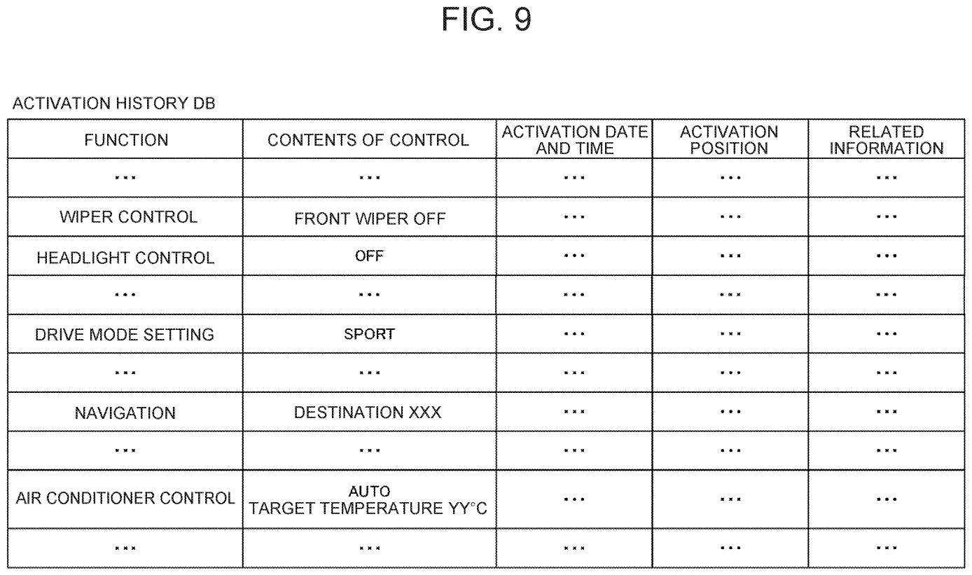

In the storage unit 110, an activation history database (activation history DB) storing an activation history of various functions belonging to the vehicle 1 is generated. FIG. 9 is a view showing one example of a table configuration of the activation history DB stored in the storage unit 110. As shown in FIG. 9, the activation history DB has a function field, a control contents field, an activation date and time field, an activation position field, and a relevant information field. In the function field, a function to be activated is input. In the control contents field, contents of control in the control command (i.e., the contents of activation of the function to be activated) are input. In the activation date and time field, the activation date and time of the function to be activated are input. In the activation position field, the activation position of the function to be activated is input. In the relevant information field, relevant information is input. The activation history DB may be built in the auxiliary storage unit as a program of a database management system is executed by the processor of the ECU 10.

The agent unit 107 generates and outputs proposal information for the driver. The proposal information is information that prompts the driver to activate various functions belonging to the vehicle 1. Here, it is assumed that in a specific situation, the driver has activated a specific function by manipulating the interface screen displayed on the outer display 23 or the inner display 22, and specific control has been thereby performed. In this case, in a situation that is the same as or similar to the specific situation, the driver is highly likely to desire that the specific control be performed again by the specific function.

Therefore, for each first predetermined function and each second predetermined function, the agent unit 107 sets proposal information and a proposal condition that is a condition for outputting the corresponding proposal information. Hereinafter, the condition for outputting the proposal information for a first predetermined function may also be referred to as a “first proposal condition.” The condition for outputting the proposal information for a second predetermined function may also be referred to as a “second proposal condition.” The agent unit 107 sets the proposal information for each first predetermined function and the first proposal condition corresponding to each proposal information based on a past activation history of that first predetermined function stored in the activation history DB. The agent unit 107 sets the proposal information for each second predetermined function and the second proposal condition corresponding to each proposal information based on a past activation history of that second predetermined function stored in the activation history DB. In this case, the agent unit 107 may set the proposal information and the proposal condition by, for example, machine learning using data stored in the activation history DB. The agent unit 107 stores the set proposal information and proposal condition for various functions in the storage unit 110.

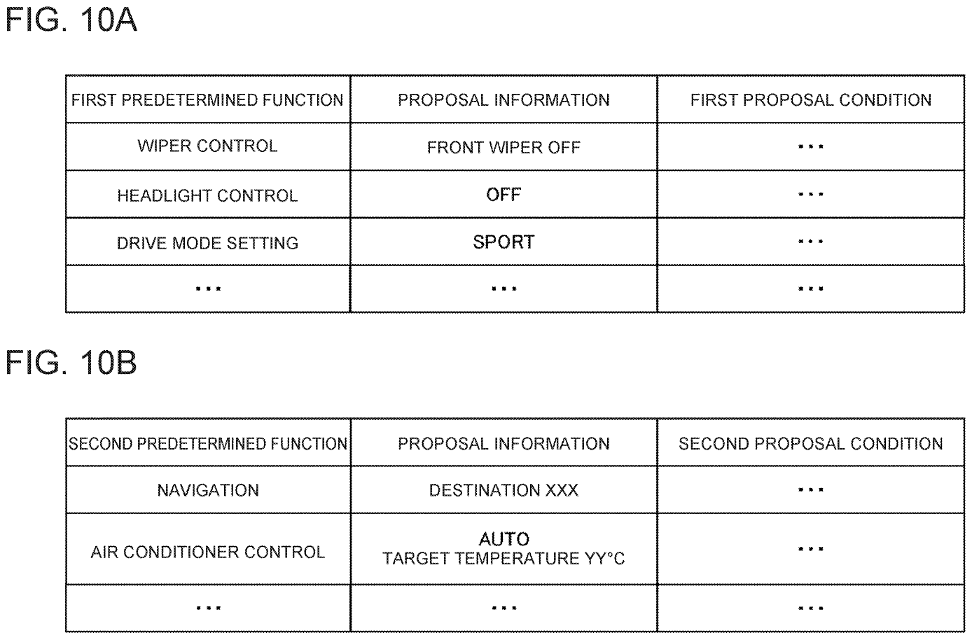

In the storage unit 110, a proposal information database (proposal information DB) storing the proposal information and the proposal condition for various functions is generated. FIG. 10A and FIG. 10B are views showing one example of a table configuration of the proposal information DB stored in the storage unit 110. Here, FIG. 10A shows the proposal information DB storing the proposal information and the proposal condition for each first predetermined function. FIG. 10B shows the proposal information DB storing the proposal information and the proposal condition for each second predetermined function. As shown in FIG. 10A and FIG. 10B, the proposal information DB stores the proposal information corresponding to each first predetermined function or each second predetermined function and the first proposal condition or the second proposal condition corresponding to each proposal information.

FIG. 10A illustrates “wiper control,” “headlight control,” and “drive mode setting” as the first predetermined functions. As the proposal information for “wiper control,” “front wiper off” (i.e., controlling the front wiper to off) is illustrated. As the proposal information for “headlight control,” “OFF” (i.e., controlling the headlights to off) is illustrated. As the proposal information for “drive mode setting,” “SPORT” (i.e., setting the drive mode to the sport mode) is illustrated. Here, the first proposal condition for outputting “controlling the headlight to off” as the proposal information for “headlight control” is that, for example, the vehicle 1 has been parked at a predetermined place during predetermined hours. In this case, the predetermined hours and the predetermined place are specified based on the activation history of headlight control (a history of activation for turning the headlights off) stored in the activation history DB. The first proposal condition for outputting “setting the drive mode to the sport mode” as the proposal information for “drive mode setting” is, for example, that the vehicle 1 is traveling on a predetermined road at a predetermined speed and a predetermined acceleration rate. In this case, the predetermined road as well as the predetermined speed and the predetermined acceleration rate are specified based on the activation history of the drive mode setting (a history of activation for setting the drive mode to the sport mode) stored in the activation history DB.

FIG. 10B illustrates “navigation” and “air conditioner control” as the second predetermined functions. As the proposal information for “navigation,” “destination XXX” (i.e., route guidance to destination XXX) is illustrated. As the proposal information for “air conditioner control,” “AUTO target temperature YY °C” (i.e., automatic operation with the target temperature set to YY °C) is illustrated. Here, the second proposal condition for outputting “starting route guidance to destination XXX” as the proposal information for “navigation” can be, for example, that driving of the vehicle 1 is started at a predetermined date and time. In this case, the predetermined date and time are specified based on a navigation activation history (a history of activation for setting the destination to XXX) stored in the activation history DB.

When one of the first proposal conditions and the second proposal conditions stored in the proposal information DB is met, the agent unit 107 outputs the corresponding proposal information. In this case, it is conceivable to set the output destination of the proposal information to the AI assistant screen displayed on the inner display 22. In this case, the agent unit 107 displays the AI assistant screen on the inner display 22 by the HMI control unit 101. After that, the agent unit 107 outputs proposal information to the AI assistant screen displayed on the inner display 22. This helps the driver grasp that a proposal has been made to himself or herself from the AI assistant.

However, the first interfaces relating to the first predetermined functions are displayed on the outer display 23 instead of the inner display 22. At a timing when the first proposal condition relating to a specific first predetermined function is met, the driver may have the first interface relating to the specific first predetermined function displayed on the outer display 23 to perform manipulation about the specific first predetermined function. Thus, when the first interface relating to the specific first predetermined function is displayed on the outer display 23, it is highly probable that the driver is intended to manipulate a manipulation icon included in the first interface. Accordingly, the driver is more likely to view the outer display 23 than the inner display 22. Therefore, when the first proposal condition relating to a specific first predetermined function is met and at that time the first interface relating to the specific first predetermined function is displayed on the outer display 23, the agent unit 107 outputs the proposal information to the first interface relating to the specific first predetermined function displayed on the outer display 23. This further helps the driver grasp the proposal information relating to the specific first predetermined function from the AI assistant.

On the other hand, the second interfaces relating to the second predetermined functions are displayed on the inner display 22. At a timing when the second proposal condition relating to a specific second predetermined function is met, the driver may have the second interface relating to the specific second predetermined function displayed on the inner display 22 to perform manipulation about the specific second predetermined function. In such a situation, if the AI assistant screen is displayed on the inner display 22, the driver can view the AI assistant screen. Therefore, the agent unit 107 outputs the proposal information to the AI assistant screen after displaying the AI assistant screen on the inner display 22.

### Proposal Information Output Flow

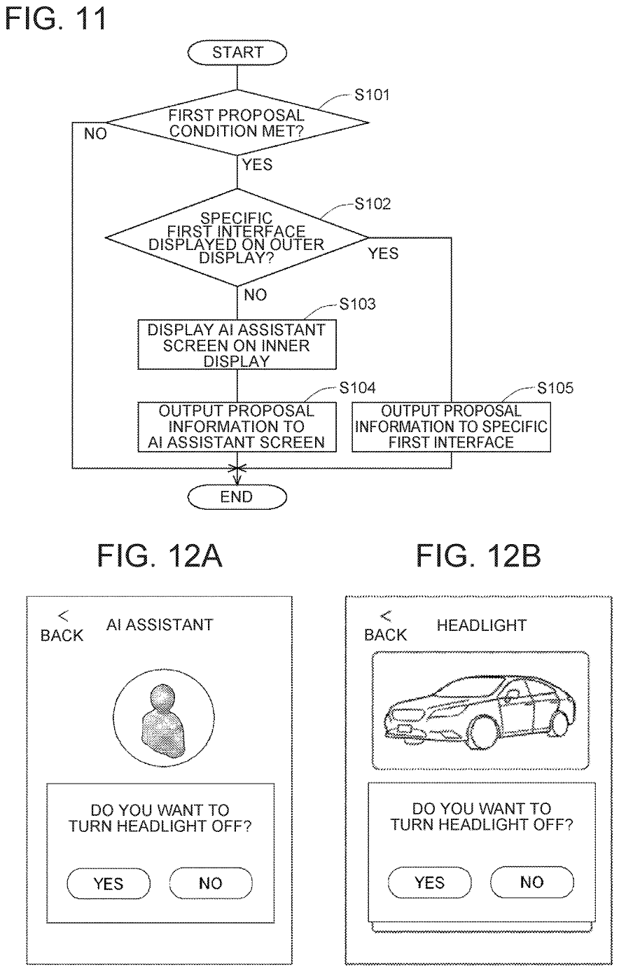

In the following, a control flow in the case where the agent unit 107 outputs the proposal information for the first predetermined function will be described based on FIG. 11. FIG. 11 is a flowchart showing the control flow in the case where proposal information for a first predetermined function is output. This flow is executed repeatedly at predetermined intervals by the agent unit 107.

In this flow, first, in S101, it is determined whether one of the first proposal conditions relating to one of the first predetermined functions that are stored in the proposal information DB is met. When the determination result is negative in S101, execution of this flow is temporarily ended. On the other hand, when the determination result is affirmative in S101, the process of S102 is executed next.

In S102, it is determined whether the first interface relating to the specific first predetermined function (hereinafter may also be referred to as a “specific first interface”) corresponding to the first proposal condition that has been determined to be met in S101 is displayed on the outer display 23. When the determination result is negative in S102, the process of S103 is executed next. In S103, the AI assistant screen is displayed on the inner display 22 by the HMI control unit 101. Next, in S104, the proposal information corresponding to the first proposal condition (i.e., the proposal information relating to the specific first predetermined function) that has been determined to be met in S101 is output to the AI assistant screen displayed on the inner display 22. Thereafter, execution of this flow is temporarily ended.

On the other hand, when the determination result is affirmative in S102, the process of S105 is executed next. In S105, the proposal information is output to the specific first interface displayed on the outer display 23. Thereafter, execution of this flow is temporarily ended.

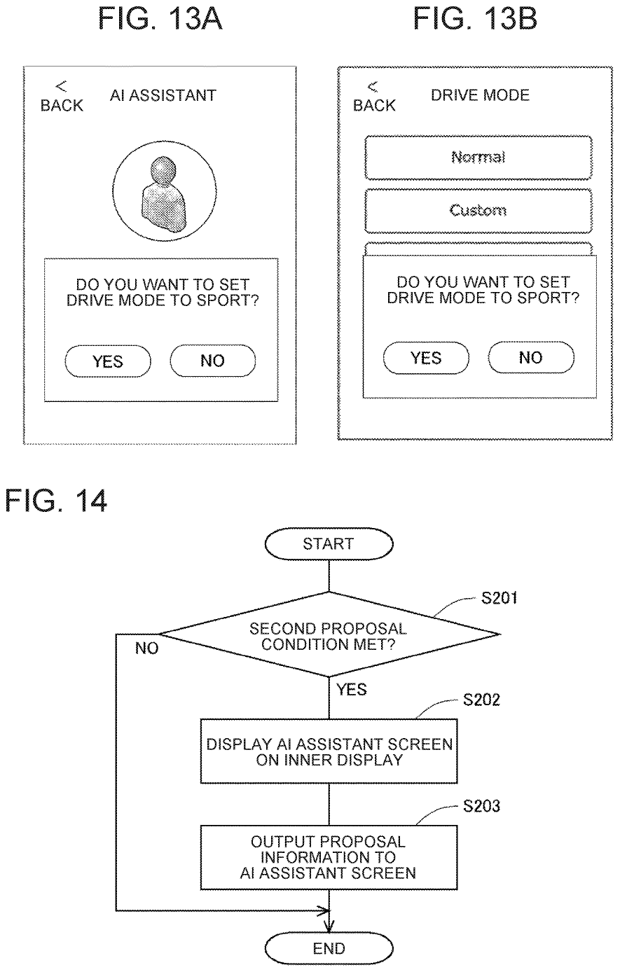

FIG. 12A, FIG. 12B, FIG. 13A, and FIG. 13B are views showing examples of displayed images on the inner display 22 and displayed images on the outer display 23 when the proposal information has been output as a result of executing the flow shown in FIG. 11 as described above. FIG. 12A and FIG. 12B show the displayed images in the case where the first proposal condition is met under which “controlling the headlights to off” is output as the proposal information relating to the headlight control function that is one type of the first predetermined functions. FIG. 12A is one example of displayed images on the inner display 22, and FIG. 12B is one example of displayed images on the outer display 23.

Here, when it is determined in S102 of the flow shown in FIG. 11 that the headlight control screen that is the specific first interface is not displayed on the outer display 23, the display as shown in FIG. 12A is displayed on the inner display 22. That is, the AI assistant screen is displayed on the inner display 22. Then, proposal information that proposes “controlling the headlights to off” is displayed on the AI assistant screen. On the other hand, when it is determined in S102 of the flow shown in FIG. 11 that the headlight control screen that is the specific first interface is displayed on the outer display 23, the displayed image as shown in FIG. 12B is shown on the outer display 23. That is, the proposal information that proposes “controlling the headlights to off” is displayed on the headlight control screen displayed on the outer display 23.

FIG. 13A and FIG. 13B show the displayed images in the case where the first proposal condition is met under which “setting the drive mode to the sport mode” is output as the proposal information relating to the drive mode setting function that is one type of the first predetermined functions. FIG. 13A is one example of displayed images on the inner display 22, and FIG. 13B is one example of displayed images on the outer display 23.

Here, when it is determined in S102 of the flow shown in FIG. 11 that the drive mode setting screen that is the specific first interface is not displayed on the outer display 23, the displayed image as shown in FIG. 13A is displayed on the inner display 22. That is, the AI assistant screen is displayed on the inner display 22. Proposal information that proposes “setting the drive mode to the sport mode” is displayed on the AI assistant screen. On the other hand, when it is determined in S102 of the flow shown in FIG. 11 that the drive mode setting screen that is the specific first interface is displayed on the outer display 23, the displayed image as shown in FIG. 13B is displayed on the outer display 23. That is, the proposal information that proposes “setting the drive mode to the sport mode” is displayed on the drive mode setting screen displayed on the outer display 23.

In each case of FIG. 12A, FIG. 12B, FIG. 13A, and FIG. 13B, manipulation icons (a “YES” icon and a “NO” icon) for the driver to respond to the proposal information are displayed along with the proposal information on the screen.

Next, a control flow in the case where the agent unit 107 outputs proposal information for a second predetermined function will be described based on FIG. 14. FIG. 14 is a flowchart showing the control flow in the case where proposal information for a second predetermined function is output. Like the flowchart shown in FIG. 11, this flow is executed repeatedly at predetermined intervals by the agent unit 107.

In this flow, first, in S201, it is determined whether a second proposal condition relating to one of the second predetermined functions that are stored in the proposal information DB is met. When the determination result is negative in S201, execution of this flow is temporarily ended. On the other hand, when the determination result is affirmative in S201, the process of S202 is executed next.

In S202, the AI assistant screen is displayed on the inner display 22 by the HMI control unit 101. Next, in S203, proposal information corresponding to the second proposal condition that has been determined to be met in S201 (i.e., the proposal information relating to the specific second predetermined function) is output to the AI assistant screen displayed on the inner display 22. Thereafter, execution of this flow is temporarily ended.

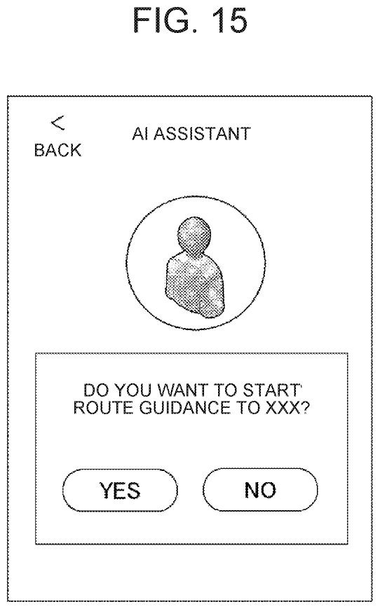

FIG. 15 is a view showing one example of displayed images on the inner display 22 in the case where proposal information has been output as a result of executing the flow shown in FIG. 14 as described above. FIG. 15 shows the displayed image in the case where a second proposal condition is met under which “route guidance to destination XXX” is output as proposal information relating to the navigation function that is one type of the second predetermined functions. In this case, as shown in FIG. 15, the AI assistant screen is displayed on the inner display 22. The proposal information that proposes “route guidance to destination XXX” is displayed on the AI assistant screen.

The flow of outputting proposal information according to this embodiment can output proposal information to a display that the driver is more likely to view in the case where proposal information relating to a first predetermined function or a second predetermined function is output in the display device 20 having a plurality of displays (the inner display 22 and the outer display 23). This further helps the driver grasp the proposal information. Accordingly, the user's (driver's) convenience in the case where information is provided to the user can be improved.

### Other Embodiments

The above-described embodiment is merely one example, and the present disclosure can be implemented with changes made thereto as appropriate within such a range that no departure is made from the gist of the disclosure. The processes and means described in the present disclosure can be implemented in arbitrary combinations to such an extent that no technical inconsistency arises.

A process that has been described as being performed by one device may be shared and executed by a plurality of devices. Alternatively, processes that have been described as being performed by different devices may be executed by one device. In the computer system, by what hardware configuration (server configuration) each function is realized can be flexibly changed.

The present disclosure can also be realized by supplying a computer program provided with the functions described in the above-described embodiments to a computer, and making one or more processors belonging to that computer read and execute the program. Such a computer program may be provided to a computer by a non-transitory computer-readable storage medium that can be connected to a system bus of the computer, or may be provided to a computer through a network. Examples of non-transitory computer-readable storage media include arbitrary types of discs such as magnetic discs (a floppy (R) disk, a hard disc drive (HDD), etc.) and optical discs (a CD-ROM, a DVD disc, a Blu-ray disc, etc.), and arbitrary types of media suitable for storing electronic instructions such as a read-only memory (ROM), a random-access memory (RAM), an EPROM, an EEPROM, a magnetic card, a flash memory, and an optical card.

What is claimed is:

1. An in-vehicle system comprising:
a display device including a first display and a second display; and
one or more processors configured to control the display device, wherein the first display is configured to display interfaces each including a manipulation icon that is manipulated by a driver of a vehicle, the interfaces being interfaces relating respectively to a plurality of first predetermined functions belonging to the vehicle;
the second display is configured to display interfaces relating respectively to a plurality of second predetermined functions belonging to the vehicle, the second predetermined functions being functions other than the first predetermined functions and including an agent function of outputting proposal information for the driver; and
the one or more processors are configured to execute outputting the proposal information to the first display in a case where an interface relating to one of the first predetermined functions that corresponds to a predetermined proposal condition being met is displayed on the first display when the predetermined proposal condition is met, the predetermined proposal condition being a condition under which information relating to one of the first predetermined functions is supposed to be output as the proposal information by the agent function.

2. The in-vehicle system according to claim 1, wherein the one or more processors are configured to further execute outputting the proposal information to the second display in a case where the interface relating to the one of the first predetermined functions that corresponds to the predetermined proposal condition being met is not displayed on the first display when the predetermined proposal condition is met.

3. The in-vehicle system according to claim 2, wherein:
the predetermined proposal condition is a first proposal condition; and
the one or more processors are configured to further execute the outputting of the proposal information to the second display when a second proposal condition is met under which information relating to one of the second predetermined functions is supposed to be output as the proposal information by the agent function.

4. The in-vehicle system according to claim 1, wherein the predetermined proposal condition for each of the first predetermined functions is set based on a corresponding one of information relating to a past activation history of the first predetermined functions.

5. The in-vehicle system according to claim 4, wherein the information relating to the past activation history of each of the first predetermined functions includes at least a corresponding one of information indicating an activation date and time and an activation position of the first predetermined functions.

6. The in-vehicle system according to claim 1, wherein the first predetermined functions include functions relating to control of the vehicle.

7. The in-vehicle system according to claim 6, wherein the functions relating to control of the vehicle include at least one function among a headlight control function, a wiper control function, a mirror adjustment function, a drive mode setting function, a seat position adjustment function, and an advanced driver-assistance systems (ADAS) setting function.

8. The in-vehicle system according to claim 1, wherein:
the first display and the second display are a pair of displays having a touch panel; and
on a front side of a driver seat inside a vehicle cabin of the vehicle, the first display and the second display are disposed at positions one on each side of a steering wheel while protruding toward a vehicle rear side beyond a meter provided in front of the steering wheel.

9. A vehicle comprising the in-vehicle system according to claim 1.

10. An information processing device comprising one or more processors configured to control a display device, wherein:
the display device includes a first display and a second display;
the first display is configured to display interfaces each including a manipulation icon that is manipulated by a driver of a vehicle, the interfaces being interfaces relating respectively to a plurality of first predetermined functions belonging to the vehicle;
the second display is configured to display interfaces relating respectively to a plurality of second predetermined functions belonging to the vehicle, the second predetermined functions being functions other than the first predetermined functions and including an agent function of outputting proposal information for the driver; and
the one or more processors are configured to execute outputting the proposal information to the first display in a case where an interface relating to one of the first predetermined functions that corresponds to a predetermined proposal condition being met is displayed on the first display when the predetermined proposal condition is met, the predetermined proposal condition being a condition under which information relating to one of the first predetermined functions is supposed to be output as the proposal information by the agent function.

11. The information processing device according to claim 10, wherein the one or more processors are configured to further execute outputting the proposal information to the second display in a case where the interface relating to the one of the first predetermined functions that corresponds to the predetermined proposal condition being met is not displayed on the first display when the predetermined proposal condition is met.

12. The information processing device according to claim 11, wherein:
the predetermined proposal condition is a first proposal condition; and
the one or more processors are configured to further execute the outputting of the proposal information to the second display when a second proposal condition is met under which information relating to one of the second predetermined functions is supposed to be output as the proposal information by the agent function.

13. The information processing device according to claim 10, wherein the predetermined proposal condition for each of the first predetermined functions is set based on a corresponding one of information relating to a past activation history of the first predetermined functions.

14. The information processing device according to claim 13, wherein the information relating to the past activation history of each of the first predetermined functions includes at least a corresponding one of information indicating an activation date and time and an activation position of the first predetermined functions.

15. The information processing device according to claim 10, wherein the first predetermined functions include functions relating to control of the vehicle.

16. The information processing device according to claim 15, wherein the functions relating to control of the vehicle include at least one function among a headlight control function, a wiper control function, a mirror adjustment function, a drive mode setting function, a seat position adjustment function, and an advanced driver-assistance systems (ADAS) setting function.
